(19) United States
(12) Patent Application Publication
(10) Pub. No.: US 2013/0293519 A1
(43) Pub. Date: Nov. 7, 2013

(54) GREY SCALE ELECTROMECHANICAL SYSTEMS DISPLAY DEVICE

(71) Applicants: Jian J. Ma, Carlsbad, CA (US); John Hyunchul Hong, San Clemente, CA (US); Bing Wen, Poway, CA (US); Edward Keat Leem Chan, San Diego, CA (US)

(72) Inventors: Jian J. Ma, Carlsbad, CA (US); John Hyunchul Hong, San Clemente, CA (US); Bing Wen, Poway, CA (US); Edward Keat Leem Chan, San Diego, CA (US)

(73) Assignee: QUALCOMM MEMS Technologies, Inc., San Diego, CA (US)

(21) Appl. No.: 13/463,572

(22) Filed: May 3, 2012

(51) Int. Cl. G06F 3/038; G02F 1/03

(52) U.S. Cl. 345/204; 359/263

(57) ABSTRACT

This disclosure provides systems, methods and apparatus for an electromechanical systems display device. In one aspect, a grey scale electromechanical systems display device may include a reflector assembly disposed on a support dielectric layer, a substrate, and an absorber assembly. The absorber assembly may include a metal layer. The absorber assembly may be configured to move to a first position defining a first cavity between the absorber assembly and the substrate such that the device reflects a white light. The absorber assembly also may be configured to move to a second position defining a second cavity between the absorber assembly and the reflector assembly such that the device substantially does not reflect light.

### TECHNICAL FIELD

This disclosure relates generally to electromechanical systems (EMS) display devices and more particularly to grey scale EMS display devices.

### DESCRIPTION OF THE RELATED TECHNOLOGY

Electromechanical systems (EMS) include devices having electrical and mechanical elements, actuators, transducers, sensors, optical components (including mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Additional layers of material on a component (e.g., such as the stationary layer and/or the reflective membrane) of an IMOD device or other EMS display device may change the optical properties of the component. For example, the reflective and/or absorptive characteristics of a component may be modified with the additional layers of material to create an EMS display device that is capable of reflecting a white color. A white color may be generated by combining the visible colors of light in suitable proportions.

### SUMMARY

The systems, methods and devices of the disclosure each have several innovative aspects, no single one of which is solely responsible for the desirable attributes disclosed herein.

One innovative aspect of the subject matter described in this disclosure can be implemented in a device including a reflector assembly disposed on a support dielectric layer, a substrate, and an absorber assembly. The absorber assembly may include a metal layer. The absorber assembly may be configured to move to a first position defining a first cavity between the absorber assembly and the substrate such that the device reflects a white light. The absorber assembly also may be configured to move to a second position defining a second cavity between the absorber assembly and the reflector assembly such that the device substantially does not reflect light.

In some implementations, the reflector assembly may include a reflective metal layer disposed on a surface of the support dielectric layer facing the absorber assembly, a first dielectric layer having a first refractive index disposed on the reflective metal layer, and a second dielectric layer having a second refractive index disposed on the first dielectric layer. The first refractive index may be less than the second refractive index.

In some implementations, the absorber assembly further may include a first dielectric layer having a first refractive index disposed on a surface of the metal layer facing the substrate. The substrate may include a second dielectric layer having a second refractive index disposed on a surface of the substrate facing the absorber assembly. The first refractive index may be less than the second refractive index.

Another innovative aspect of the subject matter described in this disclosure can be implemented in an apparatus including a first device, a second device, and a third device. Each device may include a substrate and further include a reflector assembly disposed on a support dielectric layer and an absorber assembly. The absorber assembly may include a metal layer. The absorber assembly may be configured to move to a first position defining a first cavity between the absorber assembly and the substrate such that the device reflects a white light. The absorber assembly also may be configured to move to a second position defining a second cavity between the absorber assembly and the reflector assembly such that the device substantially does not reflect light. The apparatus may further include a red filter disposed on the substrate and associated with the first device, a green filter disposed on the substrate and associated with the second device, and a blue filter disposed on the substrate and associated with the third device.

In some implementations, the apparatus further may include a fourth device. The fourth device may include the substrate, a reflector assembly disposed on a support dielectric layer, and an absorber assembly. The absorber assembly may include a metal layer. The absorber assembly may be configured to move to a first position defining a first cavity between the absorber assembly and the substrate such that the device reflects a white light. The absorber assembly also may be configured to move to a second position defining a second cavity between the absorber assembly and the reflector assembly such that the device substantially does not reflect light.

In some implementations, for each device, a first portion of the absorber assembly may be configured to move to the first position, and a second portion of the absorber assembly may be configured to move to the second position. Each device may reflect a percentage of light between the white light and substantially not reflecting light when the first portion of the absorber assembly is in the first position and the second portion of the absorber assembly is in the second position.

Another innovative aspect of the subject matter described in this disclosure can be implemented a device including a reflector assembly disposed on a support dielectric layer, a substrate, and an absorber assembly. The reflector assembly may include a reflective metal layer disposed on a surface of the support dielectric layer facing the absorber assembly, a first dielectric layer having a first refractive index disposed on the reflective metal layer, and a second dielectric layer having a second refractive index disposed on the first dielectric layer. The first refractive index may be less than the second refractive index. The substrate may include a third dielectric layer having a third refractive index disposed on a surface of the substrate facing the absorber assembly. The absorber assembly may include a metal layer and a fourth dielectric layer having a fourth refractive index disposed on a surface of the metal layer facing the substrate. The fourth refractive index may be less than the third refractive index.

In some implementations, the absorber assembly may be configured to move to a first position defining a first cavity between the absorber assembly and the substrate such that the device reflects a white light. The absorber assembly also may be configured to move to a second position defining a second cavity between the absorber assembly and the reflector assembly such that the device substantially does not reflect light.

In some implementations, a first portion of the absorber assembly may be configured to move to the first position, and a second portion of the absorber assembly may be configured to move to the second position. The device may reflect a percentage of light between the white light and substantially not reflecting light when the first portion of the absorber assembly is in the first position and the second portion of the absorber assembly is in the second position.

Details of one or more implementations of the subject matter described in this specification are set forth in the accompanying drawings and the description below. Although the examples provided in this disclosure are primarily described in terms of electromechanical systems (EMS) and microelectromechanical systems (MEMS)-based displays, the concepts provided herein may apply to other types of displays, such as liquid crystal displays, organic light-emitting diode (“OLED”) displays and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIGS. 9A, 9B, 10A, and 10B show examples of cross-sectional schematic illustrations of portions of grey scale electromechanical system (EMS) display devices.

FIGS. 11A-11C show examples of cross-sectional schematic illustrations of a grey scale EMS display device in a white state, a black state, and a grey state.

FIGS. 12A and 12B show examples of schematic illustrations an apparatus including grey scale EMS display devices and associated color filters.

FIG. 13 shows an example of a flow diagram illustrating a manufacturing process for a grey scale EMS display device.

FIGS. 14A and 14B show examples of cross-sectional schematic illustrations of various stages in a method of making a grey scale EMS display device.

FIGS. 15A, 15B, and 16 shows examples of the optical properties of a test grey scale EMS display device.

FIGS. 17A and 17B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical cavity defined between the absorber and the reflector. The reflector can be moved to two or more different positions, which can change the size of the optical cavity and thereby affect the reflectance of the interferometric modulator. The reflectance spectra of IMODs can create fairly broad spectral bands which can be shifted across the visible wavelengths to generate different colors. The wavelength of the spectral band can be adjusted by changing the thickness of the optical cavity, i.e., by changing the position of the reflector.

Color EMS display devices (e.g., EMS display devices capable of reflecting colored light), including IMODs, may be incorporated in a display to form a color display. Grey scale EMS display devices, capable of reflecting a white light, different brightnesses and/or tones of a white light (e.g., different brightnesses and/or tones of grey), and generating a black (i.e., absorbing light or not reflecting light), may be incorporated in a display to form a grey scale display. Another way of describing a grey of a grey scale EMS display device is that grey is between black (not reflecting light) and white (reflecting as much light across the visible spectrum as possible); i.e., grey is a level of reflectance between a white state and a black state of a grey scale EMS display device. Further, color filters may be applied to or associated with grey scale EMS display devices, which then also may be used to form a color display.

In some implementations described herein, a grey scale EMS display device may include a reflector assembly disposed on a support dielectric layer, a substrate, and an absorber assembly. The absorber assembly may include a metal layer. The absorber assembly may be configured to move to a first position defining a first cavity between the absorber assembly and the substrate such that the device reflects a white light. The absorber assembly also may be configured to move to a second position defining a second cavity between the absorber assembly and the reflector assembly such that the device substantially does not reflect light.

Particular implementations of the subject matter described in this disclosure can be implemented to realize one or more of the following potential advantages. The grey scale EMS display devices disclosed herein may have low power consumption and good spatial resolution compared to grey scale EMS display devices that use temporal modulation or spatial multiplexing. Further, the grey scale EMS display devices disclosed herein may be capable of generating a white and a black having a good white-to-black contrast ratio.

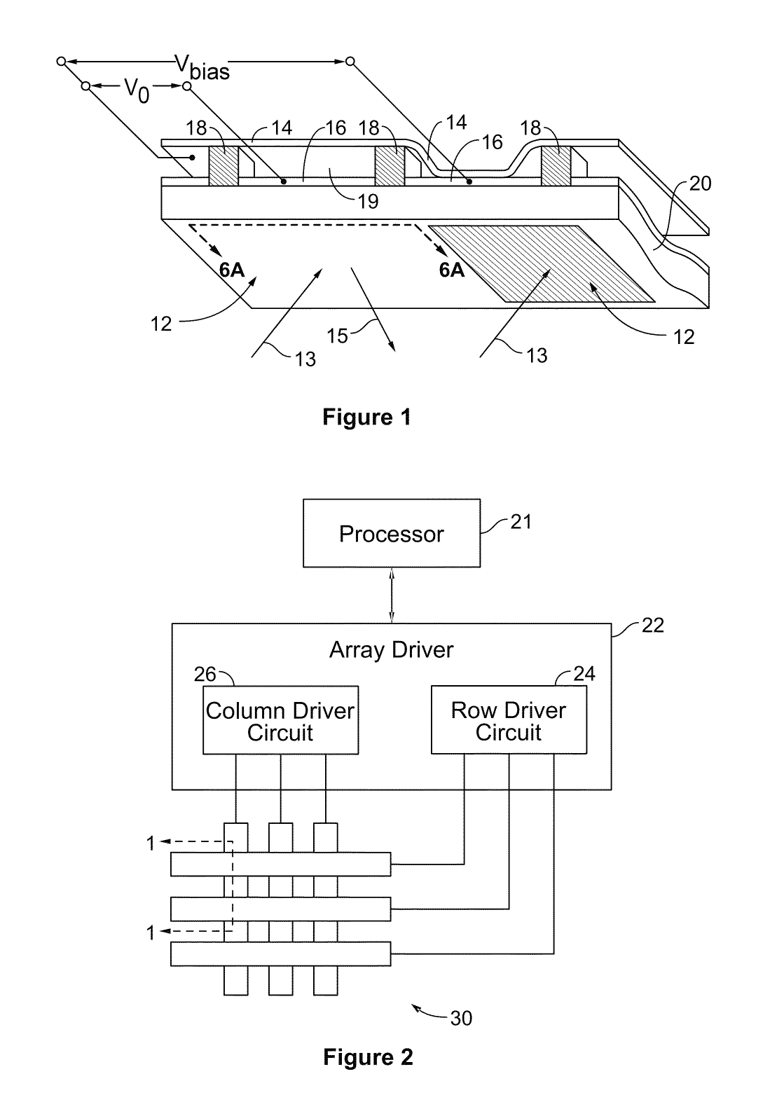

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the IMOD 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated IMOD 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

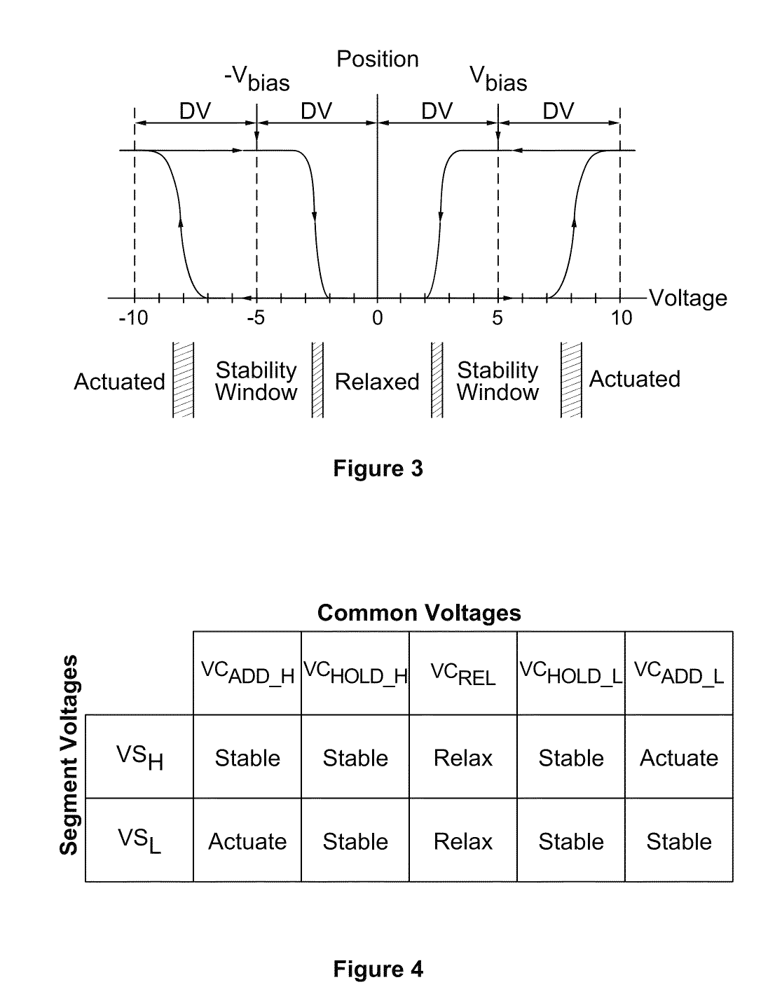

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10 volts, however, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10 volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7 volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

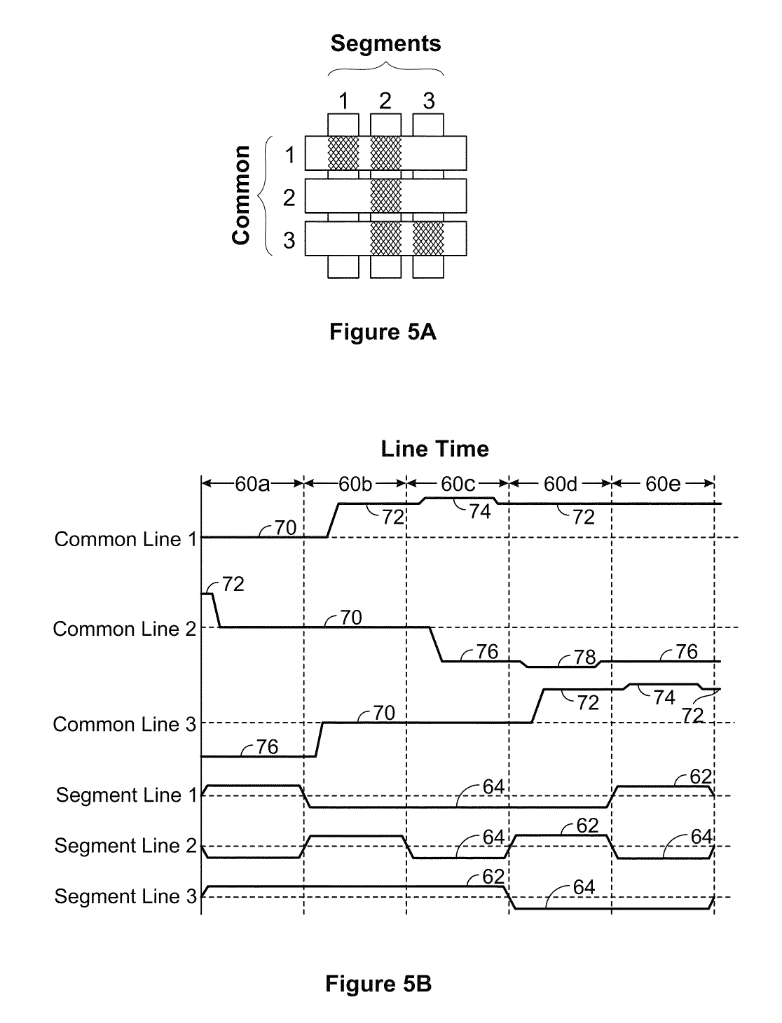

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a, a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

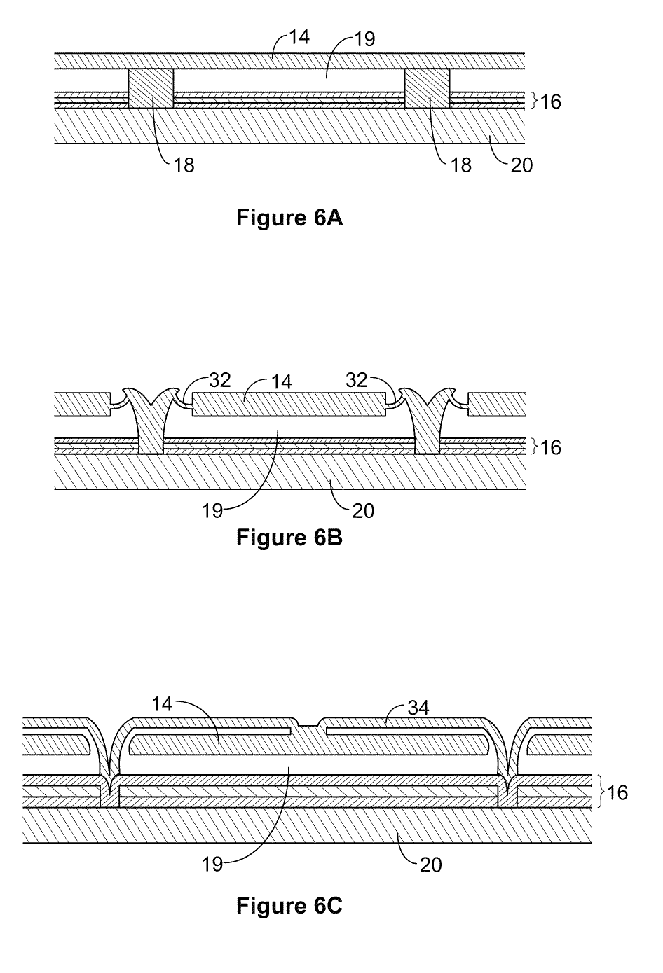

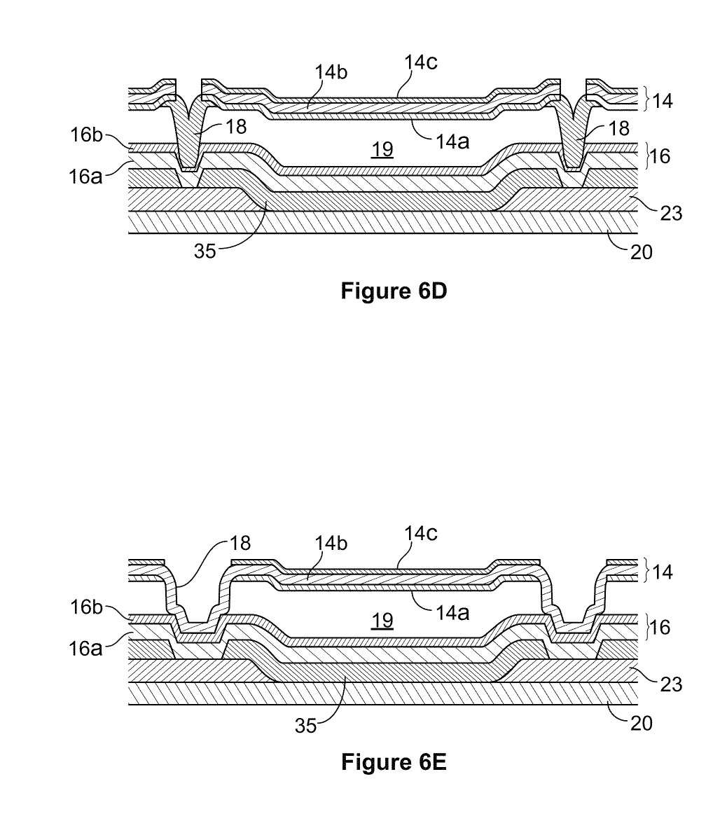

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as patterning.

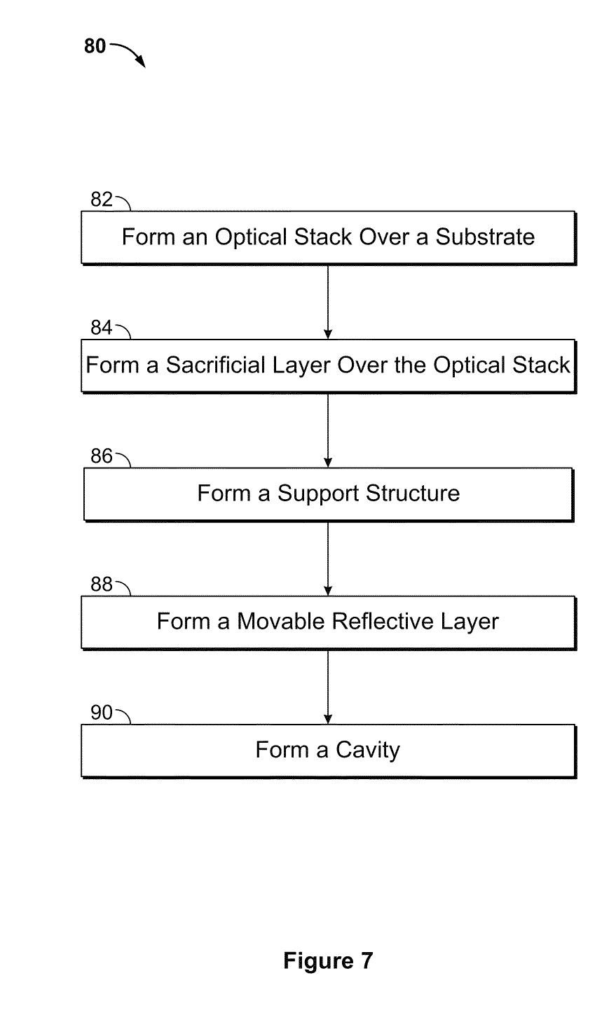

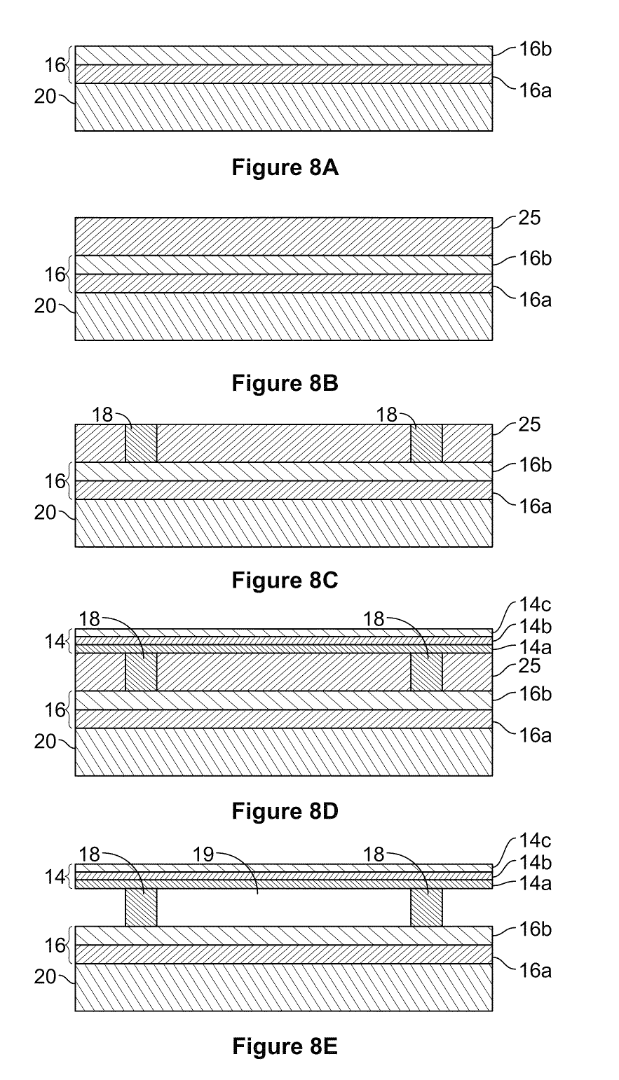

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning to remove portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition processes, e.g., reflective layer (e.g., aluminum, aluminum alloy) deposition, along with one or more patterning, masking, and/or etching processes. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other combinations of etchable sacrificial material and etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Grey scale EMS display devices are devices that can generate a white, a black, and different brightnesses and/or tones of white (e.g., different brightnesses and/or tones of grey. When combined with a color filter (e.g., a red filter, a blue filter, or a green filter), a grey scale EMS display device may generate different intensities of a primary red, green, or blue color. Some grey scale EMS display devices may use either spatial multiplexing or temporal modulation to generate a white, a black, and different brightnesses and/or tones of white. Both of these techniques (i.e., spatial multiplexing or temporal modulation), however, may compromise the spatial resolution and/or the electric power consumption of a grey scale EMS display device.

The grey scale EMS display device disclosed herein may include an absorber assembly and a reflector assembly. In a first position, the absorber assembly may define a first cavity and the device may reflect an amount of light across substantially the entire visible spectrum (i.e., a white light and the device is in a white state). In a second position, the absorber assembly may define a second cavity and the device may absorb light across substantially the entire visible spectrum or substantially not reflect light (i.e., the device is in a black state). Different layers that are part of the grey scale EMS display device may adjust the spatial dispersion of the interference standing wave pattern such that the EMS display device may reflect a large amount of light when the EMS display device is in the white state.

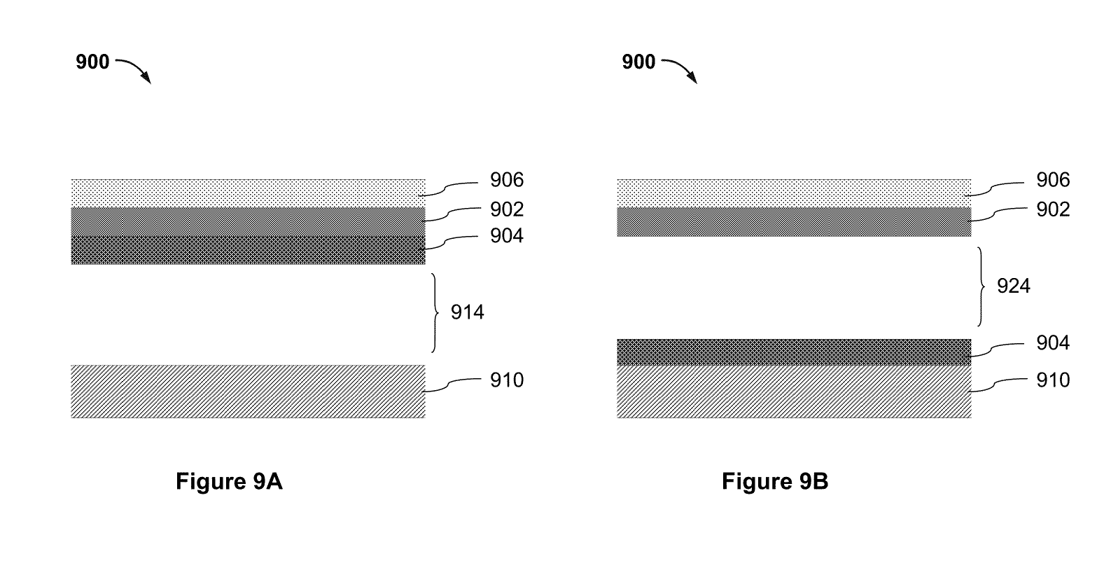

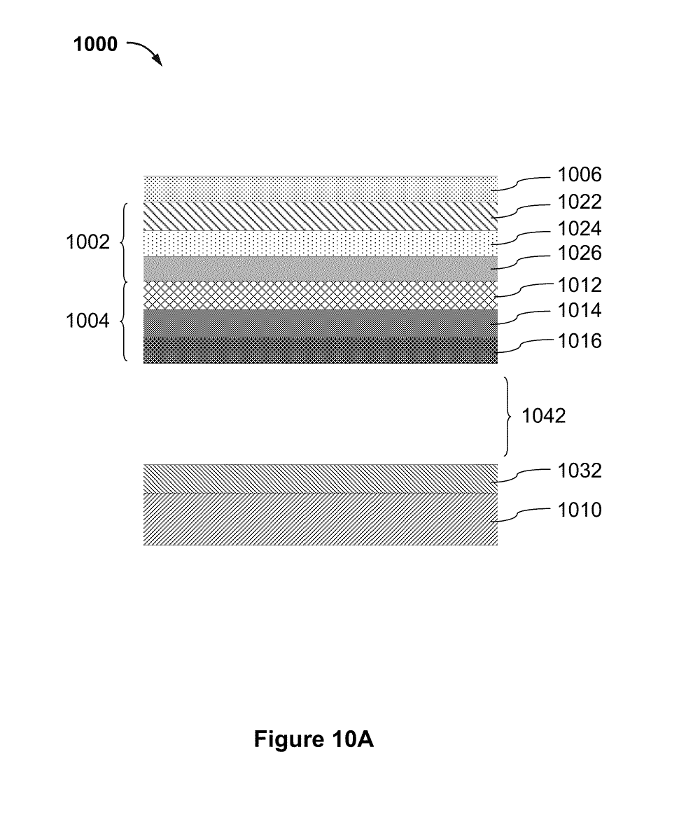

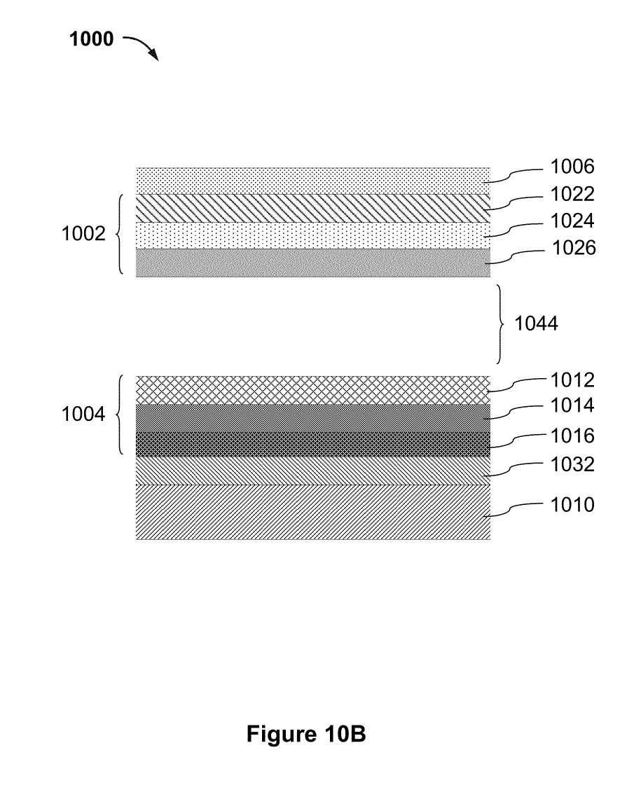

FIGS. 9A, 9B, 10A, and 10B show examples of cross-sectional schematic illustrations of portions of grey scale electromechanical system (EMS) display devices. Turning first to FIGS. 9A and 9B, a grey scale EMS display device 900 includes a reflector assembly 902 and an absorber assembly 904. In some implementations, the reflector assembly 902 and the absorber assembly 904 both may include two or more layers of different materials. In some implementations, the absorber assembly 904 may include a metal layer. The reflector assembly 902 is disposed on a support dielectric layer 906. The grey scale EMS display device 900 further includes a substrate 910. The substrate 910 may be a transparent substrate such as glass (e.g., a display glass or a borosilicate glass) or plastic, and it may be flexible or relatively stiff and unbending. The absorber assembly 904 may be connected, directly or indirectly, to the reflector assembly 902 or to the substrate 910 around the perimeter of the absorber assembly 904 by support posts (not shown).

FIG. 9A shows the grey scale EMS display device 900 in a white state; i.e., a user would see a white color through the substrate 910. In the white state, the absorber assembly 904 and the substrate 910 define a first cavity 914. In the white state, the grey scale EMS display device 900 is configured to reflect light across substantially the entire visible spectrum (i.e., the reflected color appears white). In some implementations, the first cavity 914 may be about 80 nanometers (nm) to 140 nm thick. In some implementations, when the grey scale EMS display device 900 is in the white state, substantially the entire area of a surface of the absorber assembly 904 may be in contact with the reflector assembly 902. In some other implementations, when the grey scale EMS display device 900 is in the white state, the absorber assembly 904 is in a position close to the reflector assembly 902 and there may be a gap of about 5 nm to 15 nm or about 10 nm between the absorber assembly 904 and the reflector assembly 902. For example, in some implementations, either the absorber assembly 904 or the reflector assembly 902 may include small protrusions protruding about 5 nm to 15 nm or about 10 nm from its surface. These small protrusions may aid in forming a gap between the absorber assembly 904 and the reflector assembly 902; e.g., the protrusions may set the dimensions of the gap.

FIG. 9B shows the grey scale EMS display device 900 in a black state; i.e., a user would see a black color or see substantially no light through the substrate 910. In the black state, the absorber assembly 904 and the reflector assembly 902 define a second cavity 924. In the black state, the grey scale EMS display device 900 is configured to absorb light or to substantially not reflect light. In some implementations, the second cavity 924 may be about 80 nm to 140 nm thick. In some implementations, when the grey scale EMS display device 900 is in the black state, substantially the entire area of a surface of the absorber assembly 904 may be in contact with the substrate 910. In other some implementations, when the grey scale EMS display device 900 is in the black state, the absorber assembly 904 is in a position close to the substrate 910 and there may be a gap of about 5 nm to 15 nm or about 10 nm between the absorber assembly 904 and the substrate 910. For example, in some implementations, either the absorber assembly 904 or the substrate 910 may include small protrusions protruding about 5 nm to 15 nm or about 10 nm from its surface. These small protrusions may aid in forming a gap between the absorber assembly 904 and the substrate 910; e.g., the protrusions may set the dimensions of the gap.

Turning now to FIGS. 10A and 10B, FIGS. 10A and 10B show another example of a cross-sectional schematic diagram of a portion of a grey scale EMS display device 1000. The grey scale EMS display device 1000 includes a reflector assembly 1002 and an absorber assembly 1004. The reflector assembly 1002 is disposed on a support dielectric layer 1006. The grey scale EMS display device 1000 further includes a substrate 1010.

The reflector assembly 1002 of the grey scale EMS display device 1000, as shown in FIGS. 10A and 10B, includes three layers, 1022, 1024, and 1026, of different materials. A reflective metal layer 1022 may be disposed on a surface of the support dielectric layer 1006. In some implementations, the reflective metal layer 1022 may be Al. In some implementations, the support dielectric layer 1006 may be SiO₂ or SiON. In some implementations, the support dielectric layer 1006 may be thick enough to provide a rigid structure.

A first dielectric layer 1024 may be disposed on the surface of the reflective metal layer 1022, and a second dielectric layer 1026 may be disposed on the surface of the first dielectric layer 1024. Each of the dielectric layers 1024 and 1026 has a refractive index. The refractive index of a material is a measure of the speed of light in the material. In some implementations, the material of the first dielectric layer 1024 may have a refractive index that is lower than the refractive index of the material of the second dielectric layer 1026. Examples of materials that may be used for the first dielectric layer 1024 include SiO₂, SiON, magnesium fluoride (MgF₂), aluminum oxide (Al₂O₃), hafnium fluoride (HfF₄), ytterbium fluoride (YbF₃), cryolite (sodium hexafluoroaluminate, Na₃AlF₆), and other dielectric materials. Examples of materials that may be used for the second dielectric layer 1026 include titanium oxide (TiO₂), silicon nitride (Si₃N₄), zirconium dioxide (ZrO₂), tantalum oxide (Ta₂O₅), antimony oxide (Sb₂O₃), hafnium oxide (HfO₂), scandium oxide (Sc₂O₃), indium oxide (In₂O₃), indium-tin oxide (ITO, Sn:In₂O₃), and other dielectric materials.

The absorber assembly 1004 of the grey scale EMS display device 1000, as shown in FIGS. 10A and 10B, includes three layers, 1012, 1014, and 1016, of different materials. A metal layer 1014 may be a partially absorptive and partially reflective metal, such as Cr, tungsten (W), nickel (Ni), vanadium (V), titanium (Ti), rhodium (Rh), platinum (Pt), germanium (Ge), cobalt (Co), or MoCr. In some implementations, the metal layer 1014 may be less than about 10 nm thick. In some other implementations, the metal layer 1014 may be thicker than about 10 nm. A passivation layer 1012 may be disposed on a surface of the metal layer 1014 facing the reflector assembly 1002. In some implementations, the passivation layer 1012 may be about 5 nm to 15 nm thick or about 10 nm thick. In some implementations, the passivation layer 1012 may protect the metal layer 1014 from an etchant in the manufacturing process for the grey scale EMS display device 1000. In some implementations, the passivation layer 1012 may aid in preventing stiction in the grey scale EMS display device 1000 between the metal layer 1014 and the second dielectric layer 1026.

A third dielectric layer 1016 may be disposed on the surface of the metal layer 1014 facing the substrate 1010. A fourth dielectric layer 1032 may be disposed on a surface of the substrate 1010 facing the absorber assembly 1004. In some implementations, the third dielectric layer 1016 may provide mechanical strength to absorber assembly 1004. Each of the dielectric layers 1016 and 1032 has a refractive index. In some implementations, the material of the third dielectric layer 1016 may have a refractive index that is lower than the refractive index of the material of the fourth dielectric layer 1032. Examples of materials that may be used for the third dielectric layer 1016 include SiO₂, SiON, MgF₂, Al₂O₃, and other dielectric materials. Examples of materials that may be used for the fourth dielectric layer 1032 include TiO₂, Si₃N₄, ZrO₂, Ta₂O₅, Sb₂O₃, and other dielectric materials.

The substrate 1010 may be a transparent substrate such as glass (e.g., a display glass or a borosilicate glass) or plastic, and it may be flexible or relatively stiff and unbending. In some implementations, a glass substrate may be about 400 microns to 1000 microns thick or about 700 microns thick. The absorber assembly 1004 may be connected, directly or indirectly, to the reflector assembly 1002 or to the fourth dielectric layer 1032 on the surface of the substrate 1010 around the perimeter of the absorber assembly 1004 by support posts (not shown).

FIG. 10A shows the grey scale EMS display device 1000 in a white state. In the white state, the absorber assembly 1004 and the fourth dielectric layer 1032 define a first cavity 1042. In the white state, the grey scale EMS display device 1000 is configured to reflect light across substantially the entire visible spectrum (i.e., the reflected color appears white). The dielectric layers 1024 and 1026 may substantially minimize light absorption by the metal layer 1014 when the grey scale EMS display device 1000 is in the white state. In some implementations, one or more dielectric layers may be disposed on or under the dielectric layers 1024 and 1026 to further reduce light absorption.

In some implementations, the first cavity 1042 may be about 80 nm to 140 nm thick. In some implementations, the absorber assembly 1004 may be in contact with the reflector assembly 1002, and in some other implementations, the absorber assembly 1004 may be in a position close to the reflector assembly 1002. When the absorber assembly 1004 is in a position close to the reflector assembly 1002, there may be a gap of about 5 nm to 15 nm or about 10 nm between the absorber assembly 1004 and the reflector assembly 1002. For example, in some implementations, either the absorber assembly 1004 or the reflector assembly 1002 may include small protrusions protruding about 5 nm to 15 nm or about 10 nm from its surface. These small protrusions may aid in forming a gap between the absorber assembly 1004 and the reflector assembly 1002; e.g., the protrusions may set the dimensions of the gap.

FIG. 10B shows the grey scale EMS display device 1000 in a black state. In the black state, the absorber assembly 1004 and the reflector assembly 1002 define a second cavity 1044. In the black state, the grey scale EMS display device 1000 is configured to absorb light or to substantially not reflect light. The dielectric layers 1016 and 1032 may substantially minimize reflection from the grey scale EMS display device 1000 when the device is in the black state. In some implementations, one or more dielectric layers may be disposed on or under the dielectric layers 1016 and 1032 to further reduce reflection.

In some implementations, the second cavity 1044 may be about 80 nm to 140 nm thick. In some implementations, the absorber assembly 1004 may be in contact with the fourth dielectric layer 1032, and in some other implementations, the absorber assembly 1004 may be in a position close to the fourth dielectric layer 1032. When the absorber assembly 1004 is in a position close to the fourth dielectric layer 1032, there may be a gap of about 5 nm to 15 nm or about 10 nm between the absorber assembly 1004 and the fourth dielectric layer 1032. For example, in some implementations, either the absorber assembly 1004 or the fourth dielectric layer 1032 may include small protrusions protruding about 5 nm to 15 nm or about 10 nm from its surface. These small protrusions may aid in forming a gap between the absorber assembly 1004 and fourth dielectric layer 1032; e.g., the protrusions may set the dimensions of the gap.

The thickness of each of the dielectric layers 1024, 1026, 1016, and 1032 may be specified such that the grey scale EMS display device 1000 reflects substantially a maximum amount of light across the entire visible spectrum (i.e., a white light) when the EMS display device 1000 is in the white state and reflects substantially a minimum amount of light across the entire visible spectrum (i.e., a black) with the EMS display device 1000 is in the black state. For example, the dielectric layers 1024 and 1026 may aid in reflecting a white light when the grey scale EMS display device 1000 is in the white state. The thicknesses of the dielectric layers 1024 and 1026 may be specified such that the spatial dispersion of first nulls of standing waves produced in the grey scale EMS display device 1000 are modified such that a small amount of visible light absorption (or a large amount of visible light reflection) is achieved when the absorber assembly 1004 is at the first position. The dielectric layers 1016 and 1032 may aid in generating a black when the grey scale EMS display device 1000 is in the black state. The thickness of the first dielectric layer 1024 may be about 50 nm to 80 nm. The thickness of the second dielectric layer 1026 may be about 15 nm to 30 nm. The thickness of the third dielectric layer 1016 may be about 20 nm to 60 nm. The thickness of the fourth dielectric layer 1032 may be about 10 nm to 30 nm. The thickness of each of the dielectric layers 1024, 1026, 1016, and 1032 will depend on the refractive index of the material of the dielectric layer.

For example, in some implementations, a grey scale EMS display device 1000 may include a reflector assembly 1002, with the reflector assembly 1002 including a metal layer 1022 of Al, a first dielectric layer 1024 of SiON about 77 nm thick disposed on metal layer 1022, and a second dielectric layer 1026 of TiO₂ about 22 nm thick disposed on the first dielectric layer 1024. The grey scale EMS display device 1000 also may include an absorber assembly 1004, with the absorber assembly 1004 including a metal layer 1014 of V about 7.5 nm thick, a passivation layer 1012 of Al₂O₃ about 9 nm thick disposed on a surface of the metal layer 1014 facing the reflector assembly 1002, and a third dielectric layer 1016 of SiO₂ about 22 nm thick disposed on a surface of the metal layer 1014 facing a substrate 1010. The substrate 1010 may have a fourth dielectric layer disposed on a surface of the substrate 1010 facing the absorber assembly 1004 of Si₃N₄ about 27 nm thick. A first cavity 1042 defined when the grey scale EMS display device 1000 is in the white state may be about 130 nm thick, and a second cavity 1044 defined when the grey scale EMS display device 1000 is in the black state also may be about 130 nm thick.

As noted above, the thicknesses of each or the dielectric layers 1024, 1026, 1016, and 1032 may depend on the refractive index of the material of each of the dielectric layers 1024, 1026, 1016, and 1032. For example, for the grey scale EMS display device 1000 described above including the third dielectric layer of SiO₂ about 22 nm thick, the SiO₂ of the third dielectric layer could be substituted with a layer of MgF₂ about 50 nm thick. The substitution of SiO₂ with MgF₂ may reduce the thickness of the first cavity 1042 and the second cavity 1044 to about 100 nm thick and increase the thickness of the absorber assembly 1004.

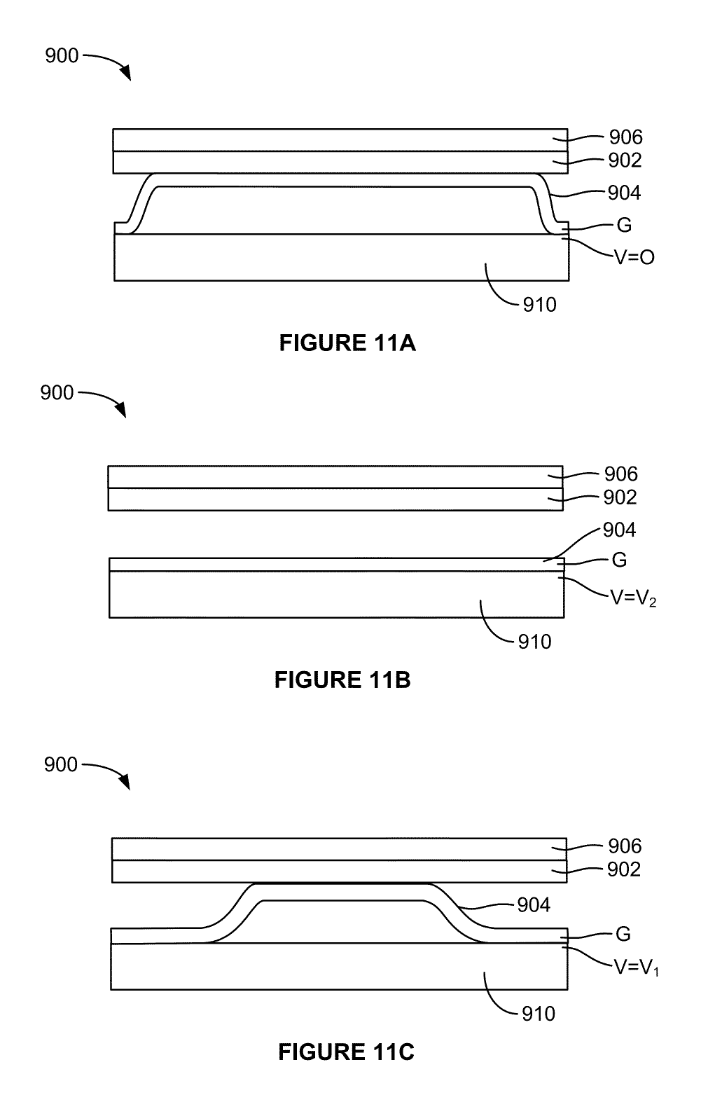

FIGS. 11A-11C show examples of cross-sectional schematic illustrations of a grey scale EMS display device in a white state, a black state, and a grey state. In FIGS. 11A-11C, simplified cross-sectional schematic illustrations of the grey scale EMS display device 900 are shown. As shown, the grey scale EMS display device 900 includes a reflector assembly 902, an absorber assembly 904, a support dielectric layer 906 on which the reflector assembly 902 is disposed, and a substrate 910.

As also shown, the absorber assembly 904 is connected directly to the substrate 910 around the perimeter of the absorber assembly 904. The manner in which the absorber assembly 904 contacts the substrate 910 may be similar to the manner in which the movable reflective layer 14 contacts the underlying optical stack 16 of the IMOD shown in FIG. 6E, for example.

In some implementations, the grey scale EMS display device 900 shown in FIGS. 11A-11C may include all of the layers of the grey scale EMS display device 1000 described above with respect to FIGS. 10A and 10B. In the implementation of the grey scale EMS display device 900 shown in FIGS. 11A-11C, the EMS display device 900 may include a transparent segmented electrode (not shown) disposed on a surface of the substrate 910 facing the absorber assembly 904. In some implementations, the transparent segmented electrode may include a transparent conductive oxide, such as indium-tin oxide (ITO). Segmented electrodes, as used herein, refer to electrodes that are mechanically segmented but electrically connected and configured to control the movement of the absorber assembly. Segmented electrodes and their modes of operation are described in more detail in U.S. patent application Ser. No. ______ (attorney docket number QCO.448A/111545U1), titled “APPARATUS FOR POSITIONING INTERFEROMETRIC MODULATOR BASED ON PROGRAMMABLE MECHANICAL FORCES,” and filed ______, which is herein incorporated by reference.

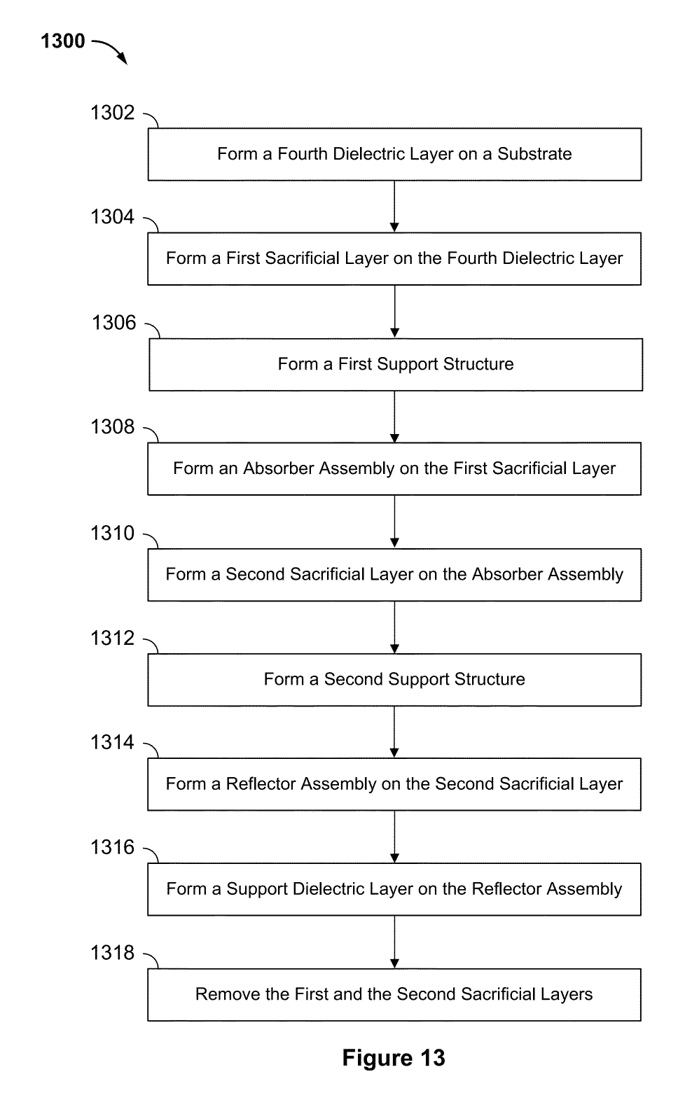

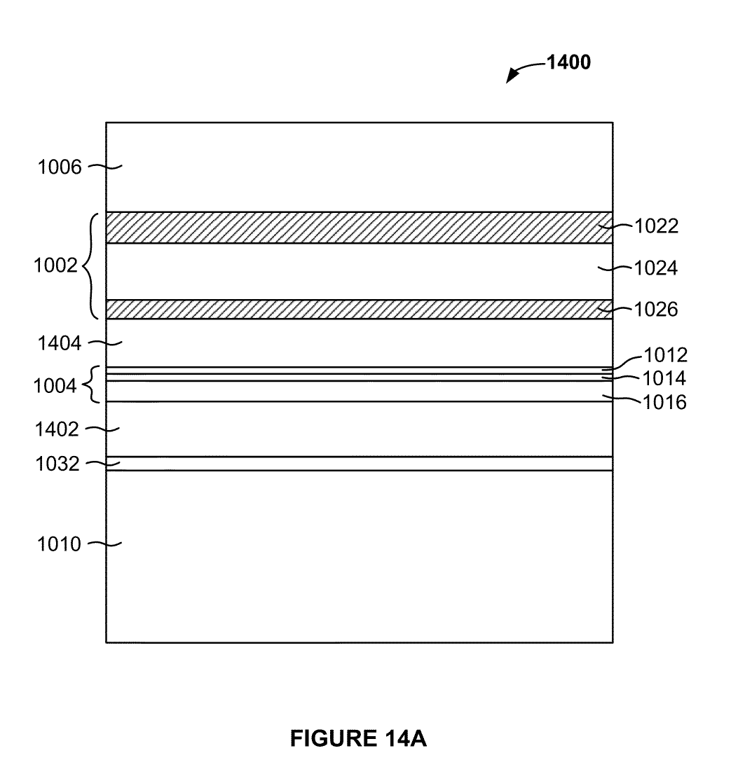

FIG. 11A shows the grey scale EMS display device 900 in a white state. As shown, in some implementations, the absorber assembly 904 may be at ground potential and the transparent segmented electrode on the surface of the substrate 910 may have no potential (i.e., V=0) applied to it. In some implementations, when the grey scale EMS display device 900 is in the white state, substantially the entire area of a surface of the absorber assembly 904 may be in contact with the reflector assembly 902. The manufacturing process for the grey scale EMS display device 900 may be tailored such that the absorber assembly 904 is in contact with the reflector assembly 902 when no potential is applied to the transparent segmented electrode on the surface of the substrate 910, as described below with respect to FIG. 13.

FIG. 11B shows the grey scale EMS display device 900 in a black state. As shown, in some implementations, the absorber assembly 904 may be at ground potential and the transparent segmented electrode on the surface of the substrate 910 may have a potential of V=V₂ applied to it. In some implementations, when the grey scale EMS display device 900 is in the black state, substantially the entire area of a surface of the absorber assembly 904 may be in contact with the substrate 910.

FIG. 11C shows the grey scale EMS display device 900 in a grey state. As shown, in some implementations, the absorber assembly 904 may be at ground potential and the transparent segmented electrode on the surface of the substrate 910 may have a potential of V=V₁ applied to it. In some implementations, the potential V₁ used to attain the grey state may be a smaller potential than the potential V₂ used in FIG. 11B to attain the black state.

In some implementations, the brightness or tone of white produced by the grey scale EMS display device 900 in a grey state may depend on the percentage of the surface of the absorber assembly 904 that is contact with the reflector assembly 902. In some implementations, a first portion of the absorber assembly 904 may be configured to be in the white state, and a second portion of the absorber assembly may be configured to be in the black state; the device 900 may reflect a percentage of light between the white state and the black state. For example, when a larger percentage of the surface of the absorber assembly 904 is in contact with the reflector assembly 902, the device 900 may generate a brighter grey.

For example, in some implementations, the actuation of the absorber assembly 904 to grey states producing different brightnesses and/or tones of white may be accomplished with the transparent segmented electrode on the surface of the substrate 910. Applying different potentials between V=0 (i.e., the white state) and V=V2 (i.e., the black state) to the transparent segmented electrode may produce different brightnesses and/or tones of white with the grey scale EMS display device 900.

In some other implementations, a grey scale EMS display device may include a segmented reflective metal layer that is part of the reflector assembly instead of a transparent segmented electrode on the surface of the substrate. The manufacturing process for such a grey scale EMS display device may be tailored such that the absorber assembly 904 is in contact with the substrate 910 when no potential is applied to the segmented reflective metal layer. Then, when a potential is applied to the segmented metal layer, a portion of the absorber assembly 904 may be brought into contact with the reflector assembly 902.

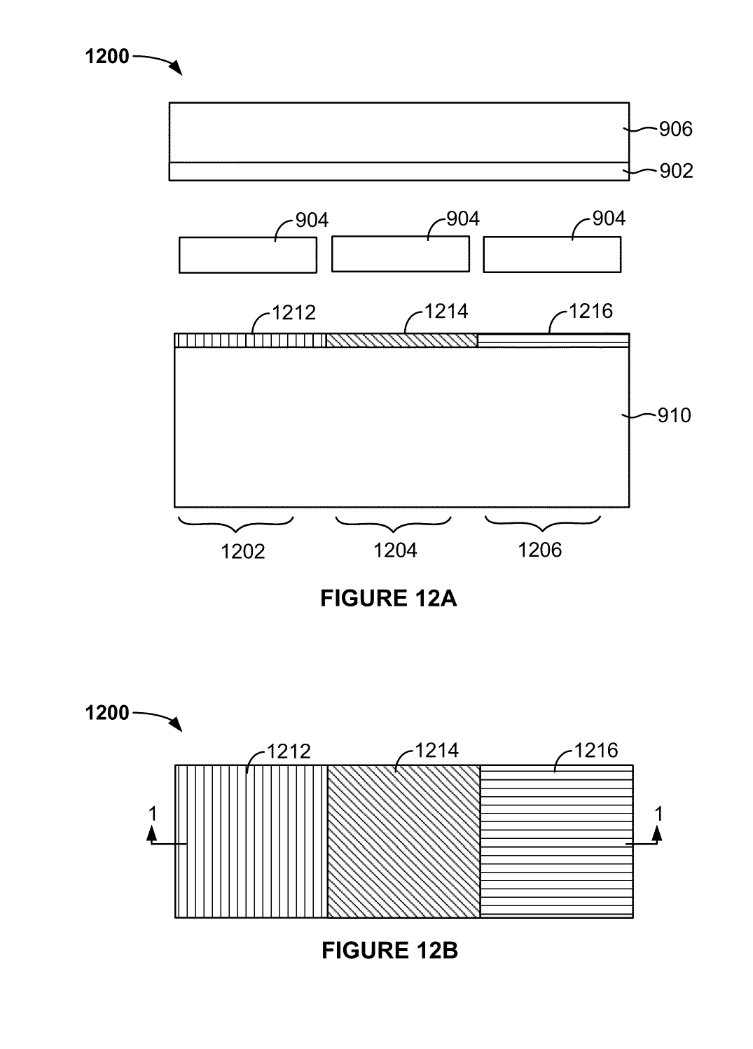

FIGS. 12A and 12B show examples of schematic illustrations an apparatus including grey scale EMS display devices and associated color filters. FIG. 12A shows an example of a cross-sectional schematic illustration of an apparatus 1200, and

FIG. 12B shows an example of a top-down schematic illustration of the apparatus 1200. The cross-sectional schematic illustration of the apparatus 1200 shown in FIG. 12A is a view though line 1-1 of FIG. 12B. FIG. 12B does not include a substrate 910, for clarity.

The apparatus 1200 shown in FIGS. 12A and 12B includes three grey scale EMS display devices, 1202, 1204, and 1206. In some implementations, each of the grey scale EMS display devices 1202, 1204, and 1206 may be similar to the grey scale EMS display device 900 as described with respect to FIGS. 9A and 9B or to the grey scale EMS display device 1000 as described with respect to FIGS. 10A and 10B. Each of the grey scale EMS display devices 1202, 1204, and 1206 may share a support dielectric layer 906, a reflector assembly 902, and a substrate 910. Each of the grey scale EMS display devices 1202, 1204, and 1206 may include an individual absorber assembly 904. In some implementations, the absorber assemblies 904 may include a metal layer.

Further, each of the grey scale EMS display devices 1202, 1204, and 1206 may have a color filter associated with it. The EMS display device 1202 has a color filter 1212 disposed on the substrate 910 associated with it. The EMS display device 1204 has a color filter 1214 disposed on the substrate 910 associated with it. The EMS display device 1206 has a color filter 1216 disposed on the substrate 910 associated with it. In some implementations, each of the color filters 1212, 1214, and 1216 may be an absorbing dye.

In some implementations, the color filter 1212 may be a red color filter, the color filter 1214 may be a green color filter, and the color filter 1216 may be a blue color filter. Thus, in some implementations, the apparatus 1200 may form a red-green-blue (RGB) pixel with the grey scale EMS display devices 1202, 1204, and 1206 forming sub-pixels; i.e., the EMS display device 1202 associated with the red color filter 1212 may form a red sub-pixel, the EMS display device 1204 associated with the green color filter 1214 may form a green sub-pixel, and the EMS display device 1206 associated with the blue color filter 1216 may form a blue sub-pixel. By mixing different intensities of red light, green light, and blue light, which may be accomplished by each of the grey scale EMS display devices 1202, 1204, and 1206 being in a white state, a black state, or a grey state, many different colors in the visible spectrum may be produced using the apparatus 1200. A number of the apparatus 1200 may be arranged to form a RGB display, for example.

In some implementations, a white sub-pixel may be added to the apparatus 1200. That is, a fourth grey scale EMS display device, without an associated color filter, may be added to the apparatus 1200. The addition of the fourth grey scale EMS display device (i.e., a white sub-pixel) may form a red-green-blue-white (RGBW) pixel, for example.

As shown in FIGS. 12A and 12B, the grey scale EMS display devices 1202, 1204, and 1206 may be arranged in line. In some other implementations, the grey scale EMS display devices 1202, 1204, and 1206 may be arranged in a triangular fashion or another manner. When a white sub-pixel is added to the apparatus 1200, the four grey scale EMS display devices may be arranged in a square fashion. Further, as shown in FIG. 12B, the color filters 1212, 1214, and 1216 and their respective grey scale EMS display devices 1202, 1204, and 1206 may be substantially square. In some other implementations, the color filters 1212, 1214, and 1216 and their respective grey scale EMS display devices 1202, 1204, and 1206 may have a different shape, such as being rectangular, triangular, circular, or oval. In some implementations, each of the grey scale EMS display devices may have dimensions of about 30 microns by 30 microns in the top-down schematic illustration shown in FIG. 12B.

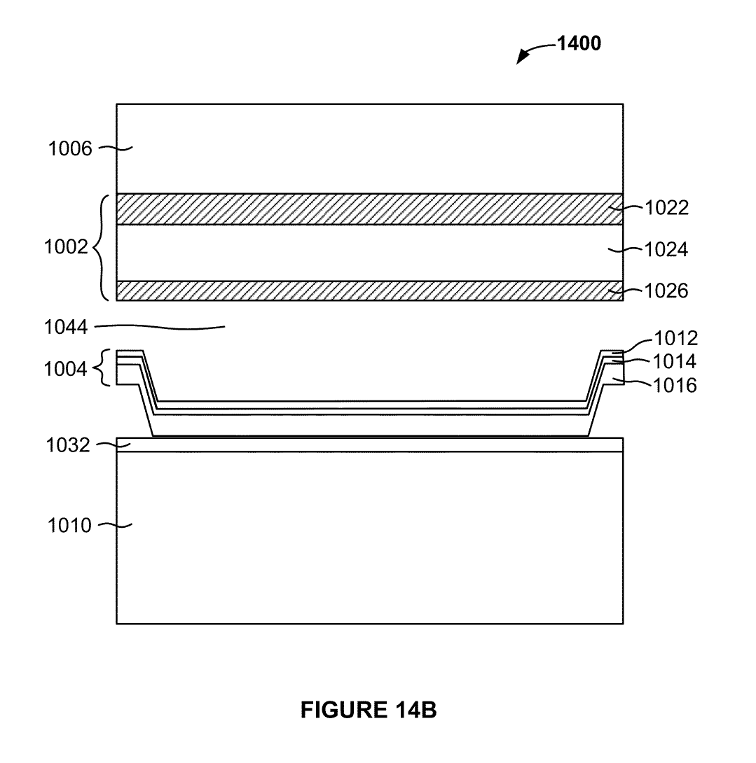

FIG. 13 shows an example of a flow diagram illustrating a manufacturing process for a grey scale EMS display device. FIGS. 14A and 14B show examples of cross-sectional schematic illustrations of various stages in a method of making a grey scale EMS display device. In some implementations, a process 1300 shown in FIG. 13 may be similar to the process 80 shown in FIG. 7 for fabricating an IMOD. The process 1300 may be used to fabricate a grey scale EMS display device similar to the grey scale EMS display device 1000 shown in FIGS. 10A and 10B or to fabricate any of the other grey scale EMS display devices disclosed herein. Further, the process 1300 may be modified to fabricate other grey scale EMS display devices.

The process 1300 may include the formation of the different layers of material included in a grey scale EMS display device. Each of these layers of material may be formed using an appropriate deposition process, including PVD processes, CVD processes, atomic layer deposition (ALD) processes, and liquid phase deposition processes. Further, in the process 1300, patterning techniques, including masking as well as etching processes, may be used to define the shapes of the different components of a grey scale EMS display device during the manufacturing process.

Starting at block 1302 of the process 1300, a fourth dielectric layer is formed on a substrate. The fourth dielectric layer may include TiO₂, Si₃N₄, ZrO₂, Ta₂O₅, Sb₂O₃, and other dielectric materials. At block 1304, a first sacrificial layer is formed on the fourth dielectric layer. The first sacrificial layer may include a XeF₂-etchable material such as Mo or amorphous Si in a thickness and size selected to provide, after subsequent removal, a cavity having a desired thickness and size. The first sacrificial layer may be formed using deposition processes including PVD processes and CVD processes.

At block 1306, a first support structure to support an absorber assembly is formed. The first support structure may include SiO₂, SiON, and other dielectric materials. The first support structure may include, for example, posts. The formation of posts may include patterning the first sacrificial layer to form a support structure aperture and then depositing the material of the first support structure into the aperture to form the posts.

At block 1308, an absorber assembly is formed on the first sacrificial layer. In some implementations, forming the absorber assembly may include forming a third dielectric layer on the first sacrificial layer, forming a metal layer on the third dielectric layer, and forming a passivation layer on the metal layer. In some implementations, the third dielectric layer may include SiO₂, SiON, MgF₂, Al₂O₃, and other dielectric materials. In some implementations, the metal layer may include Cr, W, Ni, V, Ti, Rh, Pt, Ge, Co, or MoCr. In some implementations, the passivation layer may include Al₂O₃ or another dielectric material.

At block 1310, a second sacrificial layer is formed on the absorber assembly. The second sacrificial layer may include a XeF₂-etchable material such as Mo or amorphous Si in a thickness and size selected to provide, after subsequent removal, a cavity having a desired thickness and size. In some implementations, the second sacrificial layer may have the same thickness as the first sacrificial layer, and in some other implementations, the thicknesses of the first and the second sacrificial layers may be different. The second sacrificial layer may be formed using deposition processes including PVD processes and CVD processes.

At block 1312, a second support structure to support a reflector assembly is formed. The second support structure may include SiO₂, SiON, and other dielectric materials. The second support structure may include, for example, posts. The formation of posts may include patterning the second sacrificial layer to form a support structure aperture and then depositing the material of the second support structure into the aperture to form the posts.

At block 1314, a reflector assembly is formed on the second sacrificial layer. In some implementations, forming the reflector assembly may include forming a second dielectric layer on the second sacrificial layer, forming a first dielectric layer on the second dielectric layer, and forming a reflective metal layer on the first dielectric layer. In some implementations, the second dielectric layer may include TiO₂, Si₃N₄, ZrO₂, Ta₂O₅, Sb₂O₃, HfO₂, Se₂O₃, In₂O₃, Sn:In₂O₃, and other dielectric materials. In some implementations, the first dielectric layer may include SiO₂, SiON, MgF₂, Al₂O₃, HfF₄, YbF₃, Na₃AlF₆, and other dielectric materials. In some implementations, the reflective metal layer may be Al. At block 1316, a support dielectric layer is formed on the reflector assembly. In some implementations, the support dielectric layer may be SiO₂ or SiON.

FIG. 14A shows an example of a cross-sectional schematic illustration of a partially fabricated grey scale EMS display device 1400 at this point (e.g., through block 1316) in the process 1300. The partially fabricated grey scale EMS display device 1400 includes a substrate 1010, a fourth dielectric layer 1032 disposed on the substrate 1010, a first sacrificial layer 1402 disposed on the fourth dielectric layer 1032, an absorber assembly 1004 disposed on the first sacrificial layer 1402, a second sacrificial layer 1404 disposed on the absorber assembly 1004, a reflector assembly 1002 disposed on the second sacrificial layer 1404, and a support dielectric layer 1006 disposed on the reflector assembly 1002. The absorber assembly 1004 may include a third dielectric layer 1016, a metal layer 1014, and a passivation layer 1012. The reflector assembly 1002 may include a second dielectric layer 1026, a first dielectric layer 1024, and a reflective metal layer 1022. The first and the second support structures are not shown in FIG. 14A.

Returning to FIG. 13, at block 1318 the first and the second sacrificial layers are removed. When the first and the second sacrificial layers are Mo or amorphous Si, XeF₂ may be used to remove the sacrificial layers by exposing the sacrificial layers to XeF₂.

FIG. 14B shows an example of a cross-sectional schematic illustration of the fabricated grey scale EMS display device 1400 at this point (e.g., through block 1318) in the process 1300. The fabricated grey scale EMS display device 1400 includes the substrate 1010, the fourth dielectric layer 1032 disposed on the substrate 1010, the absorber assembly 1004, the reflector assembly 1002, and the support dielectric layer 1006 disposed on the reflector assembly 1002. The absorber assembly 1004 may include the third dielectric layer 1016, the metal layer 1014, and the passivation layer 1012. The reflector assembly 1002 may include the second dielectric layer 1026, the first dielectric layer 1024, and the reflective metal layer 1022. The first and the second support structures are not shown in FIG. 14B.

As shown in FIG. 14B, the absorber assembly 1004 is in contact with the fourth dielectric layer 1032 disposed on the substrate 1010, defining a second cavity 1044, when no potential is applied to any electrodes of the grey scale EMS display device 1400. The position that the absorber assembly 1004 takes when the sacrificial layers 1402 and 1404 are removed may be determined by the types of material layers in the absorber assembly 1004, the residual stresses in the material layers, and the angles of the support structures (not shown) that support the absorber assembly 1004 and the reflector assembly 1002.

For the grey scale EMS display device 1400 shown in 14B, the reflective metal layer 1022 of the reflector assembly 1002 may be segmented and may be configured to serve as an electrode for the device 1400. The device 1400 may reflect a white light and different brightnesses and/or tones of white light (e.g., different brightnesses and/or tones of grey light) when a potential is applied to the reflective metal layer 1022. For example, when no potential is applied to the reflective metal layer 1022, the grey scale EMS display device 1400 may generate a black. When a large potential is applied to the reflective metal layer 1022, the grey scale EMS display device 1400 may generate a white. When a potential between no potential and the large potential is applied to the reflective metal layer 1022, the grey scale EMS display device 1400 may reflect different brightnesses and/or tones of white light.

In some other implementations, the grey scale EMS display device manufacturing process 1300 may include the formation of a transparent segmented electrode on the surface of the substrate 1010. The absorber assembly 1004 may be in contact with the reflector assembly 1002, defining a first cavity, when the sacrificial layers 1402 and 1404 are removed. Thus, when no potential is applied to the transparent segmented electrode, the absorber assembly 1004 may be in contact with the reflector assembly 1002. Such a grey scale EMS display device may function in a similar manner as the grey scale EMS display device 900 described above with respect to FIGS. 11A-11C.

A grey scale EMS display device being in a white state when no potential is applied to the device may be used in an electronic book (e-book) display, for example. A number of grey scale EMS display devices may be assembled as part of a display. When no potential is applied to any of the devices, the display may be white. Then, to generate text and/or pictures on the display, the appropriate grey scale EMS display devices may be actuated.

The configurations of the segmented electrodes (i.e., a transparent segmented electrode or a segmented reflective metal layer) in a grey scale EMS display device are examples of how the EMS display device may be actuated. In some other implementations, the metal layer of the absorber assembly may be segmented, and the reflective metal layer of the reflector assembly or a transparent electrode disposed on a surface of the substrate may be used to actuate the grey scale EMS display device. For example, a potential may be applied to the metal layer of the absorber assembly and either the reflective metal layer or the transparent electrode may be at a ground potential to bring the absorber assembly into contact with either reflector assembly or the substrate.

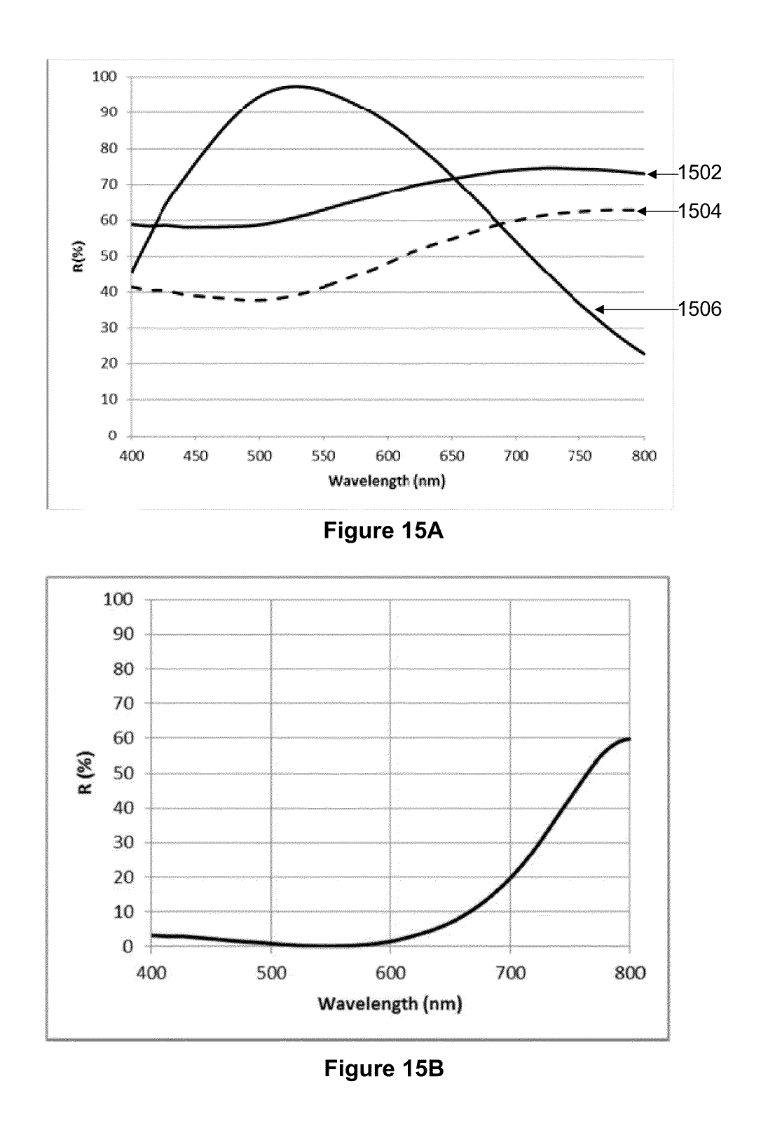

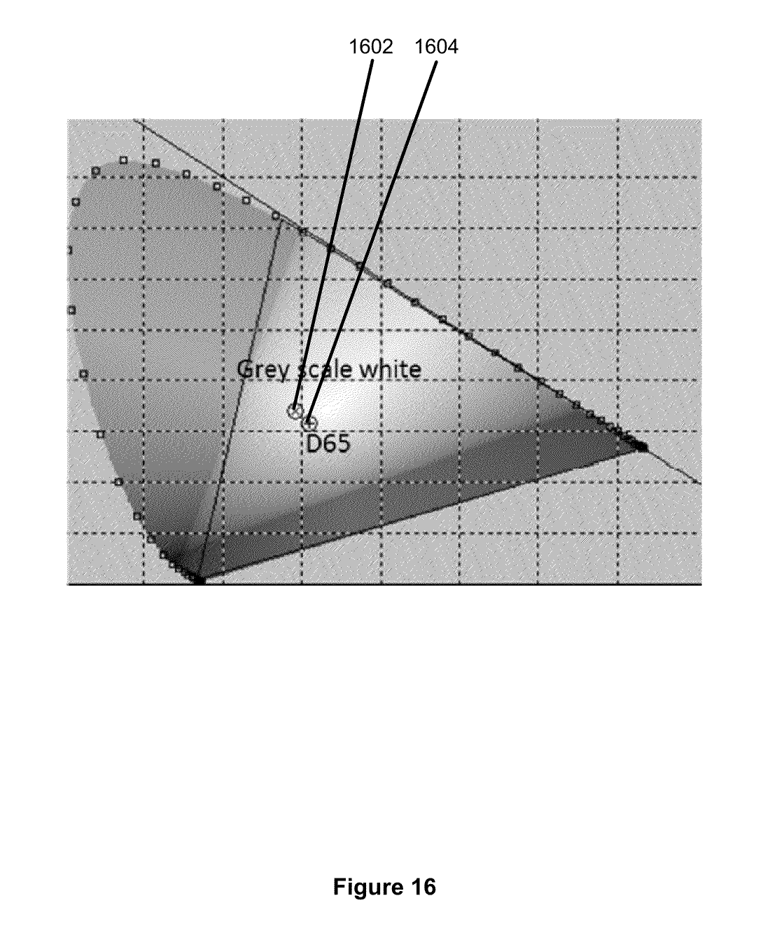

FIGS. 15A, 15B, and 16 shows examples of the optical properties of a test grey scale EMS display device. The test grey scale EMS display device included a reflector assembly including a reflective metal layer of Al, a first dielectric layer of SiON about 77 nm thick disposed on the reflective metal layer, and a second dielectric layer of TiO₂ about 22 nm thick disposed on the first dielectric layer. The test grey scale EMS display device further included an absorber assembly including a metal layer of V about 7.5 nm thick, a passivation layer of Al₂O₃ about 9 nm thick disposed on a surface of the metal layer facing the reflector assembly, and a third dielectric layer of SiO₂ about 22 nm thick disposed on a surface of the metal layer facing a substrate. The substrate of the test grey scale EMS display device had a fourth dielectric layer, disposed on the surface of the substrate facing the absorber, of Si₃N₄ about 27 nm thick. The first cavity defined when the test grey scale EMS display device was in the white state was about 130 nm thick, and second cavity defined when the test grey scale EMS display device was in the black state also was about 130 nm thick. Other metal layers, dielectric layers, and cavities of appropriate thicknesses in a grey scale EMS display device may be used to obtain similar results. Note that the results shown in FIGS. 15A, 15B, and 16 are simulated results, and are not results produced by a physical grey scale EMS display device.

FIG. 15A shows an example of plots of the reflection spectrums produced by different EMS display devices in a white state. Plots 1502 and 1504 are the reflection spectrums produced by grey scale EMS display devices including an Al reflective layer, without a first dielectric layer and a second dielectric layer disposed on the Al reflective layer, and a V absorber layer. The plot 1502 was produced with the V absorber layer contacting the Al reflective layer. The plot 1504 was produced with the V absorber layer in a position about 10 nm from the Al reflective layer. The reflection spectrums shown in plots 1502 and 1504 are low; i.e., the reflection spectrums shown in plots 1502 and 1504 show a reflectance of about 35% to 75% across the visible spectrum of about 390 to 750 nm. The luminosity of the plots 1502 and 1504 are about 64% and about 43%, respectively. Luminosity, a measurement of brightness with respect to light reflected by a perfect Lambertian surface, describes the average visual sensitivity of a human eye to light of different wavelengths. For the white state of an EMS display device, higher luminosity indicates a brighter white product by the EMS display device. The XYZ tristimulus values of the plots 1502 and 1504 are about (0.62, 0.64, 0.63) and about (0.44, 0.43, 0.42), respectively. The XYZ tristimulus values are values associated with the International Commission on Illumination (CIE) 1931 color space, a mathematically defined color space, and characterize the color of a source as seen by a human eye. For the white state of an EMS display device, higher XYZ tristimulus values, especially the Y value, indicate a brighter white able to be produced by an EMS display device.

Plot 1506 shows the reflection spectrum of the test grey scale EMS display device described with respect to this figure. The reflection spectrum shown in plot 1506 shows a reflectance peaking at about 95% at about 525 nm. The luminosity of the plot 1506 is about 92%, with XYZ tristimulus values of about (0.81, 0.92, 0.86). The improvement in the white state performance of the test grey scale EMS display device is due to the additional dielectric layers incorporated in the test grey scale EMS display device.

FIG. 15B shows an example of a plot of the spectrum produced by the test grey scale EMS display device in the black state. The luminosity of the plot shown in FIG. 15B is about 1%. Thus, the test grey scale EMS display device can achieve a white-to-black contrast ratio of about 92 to 1. A bright and pure white state with good contrast with the black state may be important, for example, in some electronic book (i.e., e-book) and mobile device display applications.

FIG. 16 shows an example of the white state produced by the test grey scale EMS display device on a CIE 1931 color space chromaticity diagram. Point 1602 indicates the chromaticity value of the white state produced by the test grey scale EMS display device. Point 1604 indicates the CIE Standard Illuminant D65. The point 1602 is close to the point 1604, indicating that the white produced by the test grey scale EMS display device is close to a pure white. As noted above, the CIE 1931 color space is a mathematically defined color space.

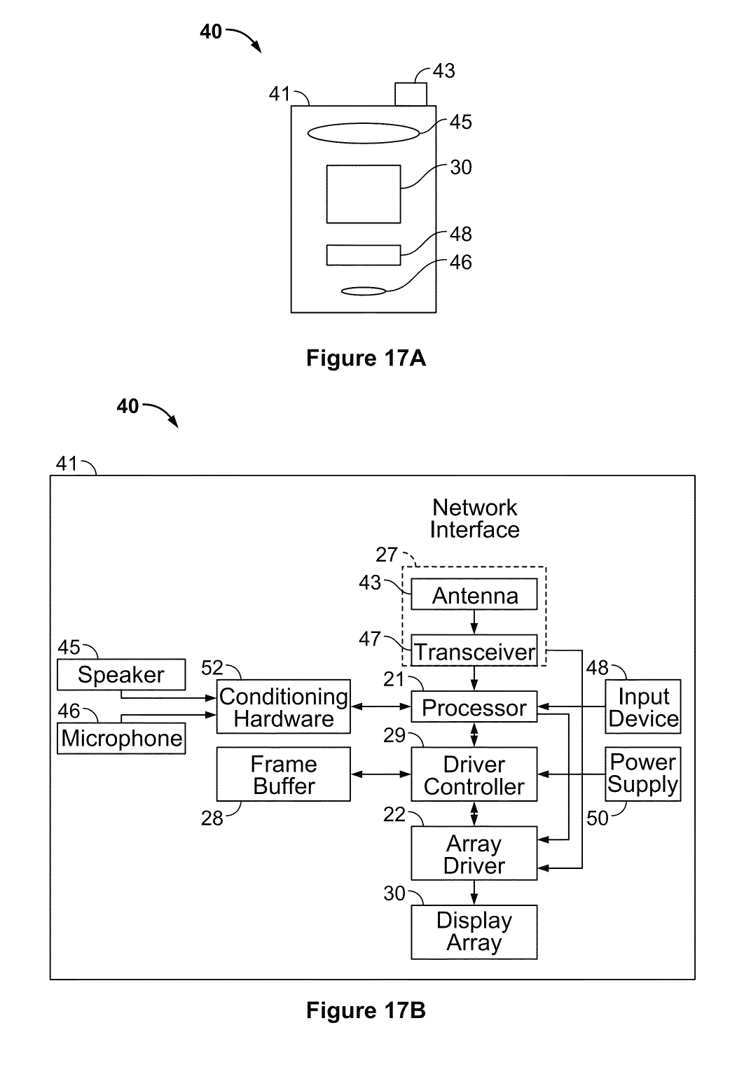

FIGS. 17A and 17B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 17B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device comprising:
a reflector assembly disposed on a support dielectric layer;
a substrate; and
an absorber assembly, the absorber assembly including a metal layer, the absorber assembly being configured to move to a first position defining a first cavity between the absorber assembly and the substrate such that the device reflects a white light, and the absorber assembly being configured to move to a second position defining a second cavity between the absorber assembly and the reflector assembly such that the device substantially does not reflect light.

2. The device of claim 1, wherein the reflector assembly includes:
a reflective metal layer disposed on a surface of the support dielectric layer facing the absorber assembly;
a first dielectric layer having a first refractive index disposed on the reflective metal layer; and
a second dielectric layer having a second refractive index disposed on the first dielectric layer, wherein the first refractive index is less than the second refractive index.

3. The device of claim 2, wherein a thickness of the first dielectric layer and a thickness of the second dielectric layer are configured to modify a spatial dispersion of first nulls of standing waves such that a small amount of visible light absorption is achieved when the absorber layer is at the first position.

4. The device of claim 1, wherein the absorber assembly further includes a first dielectric layer having a first refractive index disposed on a surface of the metal layer facing the substrate, wherein the substrate includes a second dielectric layer having a second refractive index disposed on a surface of the substrate facing the absorber assembly, and wherein the first refractive index is less than the second refractive index.

5. The device of claim 1, wherein the absorber assembly further includes a passivation layer disposed on a surface of the metal layer facing the reflector assembly.

6. The device of claim 1, wherein when the absorber assembly is in the first position, substantially an entire area of a first surface of the absorber assembly is in contact with the reflector assembly, and wherein when the absorber assembly is in the second position, substantially an entire area of a second surface of the absorber assembly is in contact with the substrate.

7. The device of claim 1, wherein a first portion of the absorber assembly is configured to move to the first position, wherein a second portion of the absorber assembly is configured to move to the second position, and wherein the device reflects a percentage of light between the white light and substantially not reflecting light when the first portion of the absorber assembly is in the first position and the second portion of the absorber assembly is in the second position.

8. The device of claim 1, further comprising:
at least one of a red filter, a green filter, and a blue filter disposed on the substrate, wherein the device is configured to reflect red light when the device includes the red filter, wherein the device is configured to reflect green light when the device includes the green filter, and wherein the device is configured to reflect blue light when the device includes the blue filter.

9. The device of claim 1, further comprising:
a transparent segmented electrode disposed on a surface of the substrate facing the absorber assembly.

10. The device of claim 1, wherein the first cavity and the second cavity each have a thickness of about 80 nanometers to 140 nanometers.

11. An apparatus comprising:
a display, the display including the device of claim 1;
a processor that is configured to communicate with the display, the processor being configured to process image data; and
a memory device that is configured to communicate with the processor.

12. The apparatus of claim 11, further comprising:
a driver circuit configured to send at least one signal to the display; and
a controller configured to send at least a portion of the image data to the driver circuit.

13. The apparatus of claim 11, further comprising:
an image source module configured to send the image data to the processor.

14. The apparatus of claim 13, wherein the image source module includes at least one of a receiver, transceiver, and transmitter.

15. The apparatus of claim 11, further comprising:
an input device configured to receive input data and to communicate the input data to the processor.

16. An apparatus comprising:
a first device, a second device, and a third device, each device including a substrate and further including:
a reflector assembly disposed on a support dielectric layer; and
an absorber assembly, the absorber assembly including a metal layer, the absorber assembly being configured to move to a first position defining a first cavity between the absorber assembly and the substrate such that the device reflects a white light, and the absorber assembly being configured to move to a second position defining a second cavity between the absorber assembly and the reflector assembly such that the device substantially does not reflect light;
a red filter disposed on the substrate and associated with the first device;
a green filter disposed on the substrate and associated with the second device; and
a blue filter disposed on the substrate and associated with the third device.

17. The apparatus of claim 16, further comprising:
a fourth device, the fourth device including the substrate and further including:
a reflector assembly disposed on a support dielectric layer; and
an absorber assembly, the absorber assembly including a metal layer, the absorber assembly being configured to move to a first position defining a first cavity between the absorber assembly and the substrate such that the device reflects a white light, and the absorber assembly being configured to move to a second position defining a second cavity between the absorber assembly and the reflector assembly such that the device substantially does not reflect light.

18. The apparatus of claim 16, wherein for each device, a first portion of the absorber assembly is configured to move to the first position, wherein a second portion of the absorber assembly is configured to move to the second position, and wherein the device reflects a percentage of light between the white light and substantially not reflecting light when the first portion of the absorber assembly is in the first position and the second portion of the absorber assembly is in the second position.

19. A device comprising:
a reflector assembly disposed on a support dielectric layer, the reflector assembly including:
a reflective metal layer disposed on a surface of the support dielectric layer facing an absorber assembly;
a first dielectric layer having a first refractive index disposed on the reflective metal layer; and
a second dielectric layer having a second refractive index disposed on the first dielectric layer, wherein the first refractive index is less than the second refractive index;
a substrate, the substrate including:
a third dielectric layer having a third refractive index disposed on a surface of the substrate facing the absorber assembly; and
the absorber assembly, the absorber assembly including:
a metal layer; and
a fourth dielectric layer having a fourth refractive index disposed on a surface of the metal layer facing the substrate, wherein the fourth refractive index is less than the third refractive index.

20. The device of claim 19, wherein the absorber assembly is configured to move to a first position defining a first cavity between the absorber assembly and the substrate such that the device reflects a white light, and wherein the absorber assembly is configured to move to a second position defining a second cavity between the absorber assembly and the reflector assembly such that the device substantially does not reflect light.

21. The device of claim 20, wherein a first portion of the absorber assembly is configured to move to the first position, wherein a second portion of the absorber assembly is configured to move to the second position, and wherein the device reflects a percentage of light between the white light and substantially not reflecting light when the first portion of the absorber assembly is in the first position and the second portion of the absorber assembly is in the second position.

22. The device of claim 19, further comprising:
at least one of a red filter, a green filter, and a blue filter disposed on the substrate, wherein the device is configured to reflect red light when the device includes the red filter, wherein the device is configured to reflect green light when the device includes the green filter, and wherein the device is configured to reflect blue light when the device includes the blue filter.
